(19) United States
(12) Patent Application Publication
(10) Pub. No.: US 2024/0339282 A1
(43) Pub. Date: Oct. 10, 2024

(54) X-RAY TUBE

(71) Applicant: CANON ELECTRON TUBES & DEVICES CO., LTD., Otawara-shi (JP)

(72) Inventor: Naoki TAKAHASHI, Nasushiobara (JP)

(73) Assignee: CANON ELECTRON TUBES & DEVICES CO., LTD., Otawara-shi (JP)

(21) Appl. No.: 18/744,783

(22) Filed: Jun. 17, 2024

Related U.S. Application Data
(63) Continuation of application No. PCT/JP2022/022734, filed on Jun. 6, 2022.

(30) Foreign Application Priority Data
Dec. 23, 2021 (JP) 2021-209305

(51) Int. Cl. H01J 35/06

(52) U.S. Cl. CPC H01J 35/066; H01J 35/064; H01J 2235/068

(57) ABSTRACT

According to one embodiment, a cathode in which three electron guns are arranged in parallel with each other, each including a filament which emits electrons, a storage slot which stores the filament, and the three electron guns are constituted by a central electron gun which opposes the anode and electron guns, a central axis of the filament along a longitudinal direction at a center of the filament in a width direction thereof and a central axis of the storage slot along a longitudinal direction at a center of the storage slot in a width direction thereof, which coincide with each other, and a central axis of the focusing cup along a longitudinal direction at a center of the focusing cup in a width direction thereof that is displaced from the central axis of the filament.

### CROSS-REFERENCE TO RELATED APPLICATIONS

This application is a Continuation Application of PCT Application No. PCT/JP2022/022734, filed Jun. 6, 2022 and based upon and claiming the benefit of priority from Japanese Patent Application No. 2021-209305, filed Dec. 23, 2021, the entire contents of all of which are incorporated herein by reference.

### FIELD

Embodiments described herein relate generally to an X-ray tube.

### BACKGROUND

Electron beams emitted from a filament are focused by storage slots and focusing cups disposed around the filament to form a focal point on a target.

When electron beams emitted from a plurality of electron guns are formed on a target to form an image, the respective focal point positions should substantially coincide with each other on the anode because a shift in focal point on the target will cause image shift. For example, in the case of three electron guns, the electron beam emitted from the center gun takes a substantially straight trajectory and impact the anode, whereas the electron beams emitted from the electron guns on both sides take a curved trajectory and head toward the anode.

On the other hand, inside the X-ray tube, desorption gas is present, and on the surface of the component, adsorption gas exists. The adsorbed gas on the surface of the component is desorbed by heat or electron impact, causing an increase in the pressure inside the tube. When the electron beam is emitted for the first time after the X-ray tube has been inactive for a long time, the adsorbed gas on the anode surface is desorbed, and some of it is ionized by the electron beam.

The electrons thus generated by this are directed toward the anode, and the positive ions are directed toward the electron gun.

Since the positive ions have a large mass, they proceed toward the filament of the central electron gun without substantially bending their trajectories. When the positive ions collide with the filament of the central electron gun, the temperature of the filament rises and such a phenomenon that the electron beams emitted from the electron gun increase may occur in some cases.

This phenomenon is less likely to occur in the next exposure because the adsorbed gas on the anode surface is less in amount. In other words, if the electron beam fluctuates between the first and second exposures, the X-ray dose emitted from the X-ray tube may vary greatly, which may cause problems when processing images. Note that this problem does not easily occur in the electron guns on the both sides because trajectories of ionized positive ions are not substantially bent.

### BRIEF DESCRIPTION OF THE DRAWINGS

FIG. 1 is a cross-sectional view of an X-ray tube device according to one embodiment.

FIG. 2, part (a) is a cross-sectional view of a cathode and an anode of the first embodiment, and FIG. 2, part (b) is a plan view of the cathode.

FIG. 3 is a cross-sectional view of a cathode and an anode according to the second embodiment.

FIG. 4, part (a) is a cross-sectional view of a cathode and an anode according to a comparative example, and FIG. 4, part (b) is a plan view of the cathode.

### DETAILED DESCRIPTION

In general, according to one embodiment, An X-ray tube comprising: an anode including a target layer that emits an X-ray when an electron beam is incident thereon;
a cathode in which three electron guns are arranged in parallel with each other, each including a filament which emits electrons, a storage slot which stores the filament, and a focusing cup which focuses the electrons emitted from the filament toward the target layer as an electron beam, wherein
the three electron guns are constituted by a central electron gun which opposes the anode and electron guns located on respective sides thereof while interposing the central electron gun therebetween, and the focusing cup of each of the electron guns is formed to be continuous to the respective slot and the filament is disposed to project out from the storage slot to the focusing cup,
the central electron gun includes a central axis of the filament along a longitudinal direction at a center of the filament in a width direction thereof and a central axis of the storage slot along a longitudinal direction at a center of the storage slot in a width direction thereof, which coincide with each other, and a central axis of the focusing cup along a longitudinal direction at a center of the focusing cup in a width direction thereof that is displaced from the central axis of the filament.

Embodiments will now be described with reference to the accompanying drawings. The disclosure is only an example, and any modification that can be easily conceived by a person skilled in the art, while maintaining the main purpose of the invention, is naturally included in the scope of the invention. In addition, the drawings may show schematically the width, thickness, shape, etc., of each part in comparison with the actual state in order to make the explanation clearer, but this is only an example and does not limit the interpretation of the invention. In addition, in this specification and in each figure, components that perform the same or similar functions as those described above with respect to the previously mentioned figures are given the same reference codes, and duplicate detailed explanations may be omitted from time to time.

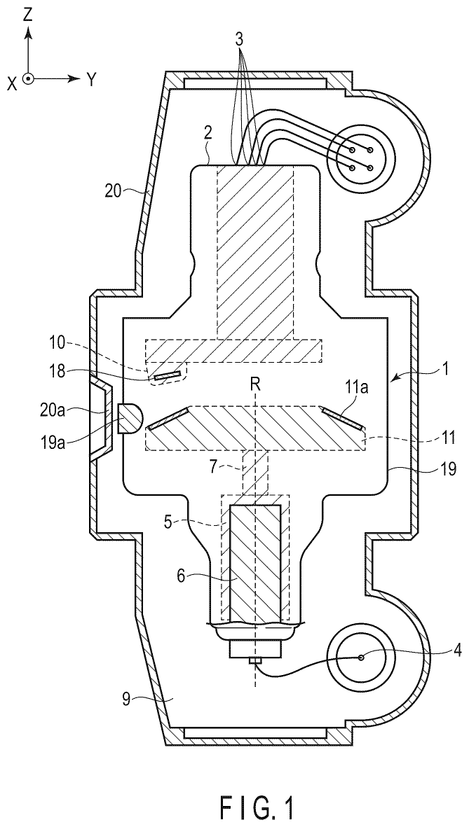

FIG. 1 is a cross-sectional view of an X-ray tube device according to one embodiment.

As shown in FIG. 1, the X-ray tube device comprises an X-ray tube 1, a housing 20, and insulating oil 9. In this embodiment, the X-ray tube 1 is a rotating anode X-ray tube.

The X-ray tube 1 comprises a cathode 10, an anode 11, a rotating body 5, a stationary body 6, a vacuum housing 19, and a stem section 2.

The rotating body 5 is formed to be cylindrical and closed at one end portion. The rotating body 5 extends along a rotation axis R, which is the central axis of the rotary motion of the rotating body. The rotating body 5 can rotate around the rotation axis R. The rotating body 5 is formed of a material such as Fe (iron) or Mo (molybdenum).

The stationary body 6 is formed into a columnar shape. The diameter of the stationary body 6 is less than an inner diameter of the rotating body 5. The stationary body 6 is provided to be coaxial with the rotating body 5 and extends along the rotation axis R. The stationary body 6 is formed of a material such as Fe or Mo. The stationary body 6 is fitted to the rotating body 5 and is also fixed to the vacuum housing 19. Although not shown in the figure, there is a gap between the rotating body 5 and the stationary body 6, which is filled with a metallic lubricant of such as a gallium-indium-tin alloy (GaInSn). For this reason, the X-ray tube 1 uses sliding bearings.

The anode 11 is positioned to oppose one end portion of the stationary body 6 in the direction along the rotation axis R. The anode 11 includes a target layer 11a located on an outer surface of the anode. The anode 11 is fixed to the rotating body 5 via a connecting member 7. The anode 11 is formed of a material such as a heavy metal, for example, Mo. The target layer 11a is formed of a metal having a melting point higher than that of the material used for the anode 11. For example, it is formed of a tungsten alloy.

The anode 11 is provided to be coaxially with the rotating body 5 and the stationary body 6. The anode 11 can rotate around the rotation axis R. The anode 11 emits X-rays when electrons emitted from the cathode 10 collide with the target layer 11a. The anode 11 is electrically connected to a terminal 4 via the rotating body 5 and the stationary body 6 and the like.

The cathode 10 includes a plurality of electron guns, in this embodiment, three electron guns 12, 13, 13 (, which will be described later). The cathode 10 is positioned to oppose the target layer 11a of the anode 11 while interposing a gap therebetween.

The vacuum housing 19 accommodates the anode 11 and the cathode 10. The vacuum housing 19 is formed of an insulating material such as glass and ceramic or a combination of an insulating material and a conductive member such as metal. The vacuum housing 19 is hermetically sealed and the inside thereof is maintained in a vacuum state. The vacuum housing 19 comprises an X-ray transmission window 19a that allows X-rays to pass through near the target layer 11a, which opposes the cathode 10. The stem section 2 is connected to the vacuum housing 19 and includes a plurality of pins 3 attached thereto.

The housing 20 accommodates the X-ray tube 1. The housing 20 comprises an X-ray transmission window 20a that allows X-rays to pass through near the target layer 11a, which opposes the cathode 10. The inside of the housing 20 accommodates the X-ray tube 1 and other components, and is filled with insulating oil 9 as a cooling liquid. Note that, although not shown in the figure, a stator coil that rotates the rotating body 5 is accommodated inside the housing 20.

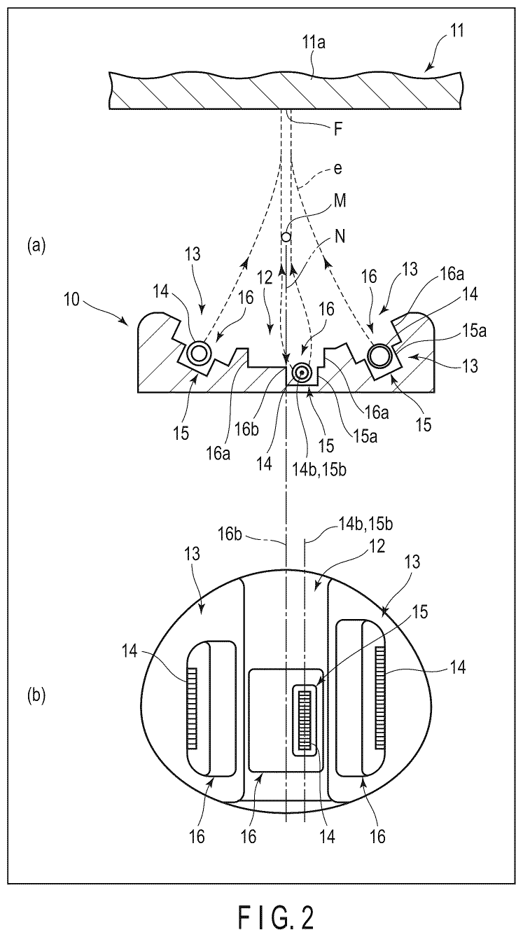

Next, the cathode 10 of the first embodiment will be described in detail with reference to FIG. 2.

FIG. 2, part (a) is a cross-sectional view of the cathode and the anode according to the first embodiment, and FIG. 2, part (b) is a plan view of the cathode shown in part (a), in a position corresponding to the cross-section of the cathode shown in part (a).

The cathode 10 includes a central electron gun 12 and electron guns 13 and 13 placed on respective sides of the central electron gun so as to interpose it therebetween, for a total of three electron guns 12, 13 and 13. The three electron guns 13, 12, 13 are arranged to be spaced apart in the direction of rotation of the target layer 11a.

Each of the electron guns 12, 13 and 13 includes a filament 14 that emits electrons e, a storage slot 15 that accommodates the filament 14, and a focusing cup 16 that focuses the electrons e emitted from the filament 14 as an electron beam toward the target layer 11a.

Each filament 14 is formed into a coil shape from a material mainly composed of tungsten. The filaments 14 and the cathodes 10 are connected respectively to pins 3 shown in FIG. 1.

As shown in FIG. 2, part (a), the central electron gun 12 is located to oppose the focal point F of the target layer 11a, and openings of the storage slot 15 and the focusing cup 16 as well are formed to oppose the focal point F of the target layer 11a. Further, a slot wall 15a of the storage slot 15 and a cup wall 16a of the focusing cup 16 are formed substantially perpendicular to the target layer 11a.

On the other hand, in the electron guns 13 and 13 placed on the respective sides, the openings of the storage slot 15 and the focusing cup 16 are formed to be inclined toward the focal point F of the target layer 11a, and the slot wall 15a of the storage slot 15 and the slot wall 16a of the focusing cup 16 are formed inclined toward the target layer 11a.

Next, with regard to the central electron gun 12, the relationship between the filament 14, the storage slot 15, and the focusing cup 16 will now be described.

The filament 14 includes a long-scale central axis 14b of the filament along its longitudinal direction at the center of its width direction (or center of the coil), and the storage slot 15 includes, as in the case of the filament 14, a long-scale central axis 15b of the storage slot along its longitudinal direction at the center of its width direction. The focusing cup 16 includes an axis parallel to the filament central axis 14b and a central axis 16b of the focusing cup along the longitudinal direction at the center of the width direction.

As shown in FIG. 2, part (a), the central

axis 14b of the filament and the central axis 15b of the storage slot are coincident and coaxial, and the central axis 16b the focusing cup is displaced from the central axis 14b of the filament.

The displacement between the central axis 16b the focusing cup from the central axis 14b of the filament is a half the width or more (or a dimension of the radius or more) of the filament 14. Here, this displacement should be large, that is, it should preferably be displaced, for example, by a half the width or more (or a dimension of the diameter or more) of the filament 14.

The cathode 10 is provided to surround the trajectory of electrons e from the filament 14 to the anode 11, and functions as a focusing electrode.

Next, the operations and effects of the first embodiment will be described.

To each of the filaments 14 and the cathode 10, a relatively negative voltage is applied. A relatively positive voltage is applied to the anode 11. Since an X-ray tube voltage (hereinafter referred to as the tube voltage) is applied between the anode 11 and the cathode 10, electrons emitted from the filament 14 are accelerated and injected into the target layer 11a as an electron beam. Here, for example, the tube voltage is between 50 kv or higher and 160 kv or less.

The electrons e emitted from each filament 14 of the central electron gun 12 and the electron guns 13, 13 on both sides are focused by the electric field near the opening of the focusing cup 16, respectively, and are injected as a bent electron beam at the focal point F on the target layer 11a. At this time, the electron beams from the electron guns 13 and 13 on the respective sides are greatly bent and injected into the focal point F.

On the other hand, when there are adsorbed gas particles M between the cathode 10 and the anode 11, the adsorbed gas particles M produce negative ions and positive ions by ionization. Of these, the positive ions having larger mass proceed toward the central electron gun 12 without being substantially bent.

Here, according to this embodiment, in the central electron gun 12, the central axis 14b of the filament and the central axis 15b of the storage slot coincide with each other, but the central axis 16b of the focusing cup is displaced from the central axis 14b of the filament. With this structure, the positive ions collide at a position displaced from the central axis 14b of the filament, as shown by arrow N, and thus the impact of the positive ions can be suppressed and the increase in electron beam due to the temperature rise of the filament 14 can be suppressed. In this manner, the fluctuation of the electron beam between the first exposure, in which there are a number of adsorbed gas particles M, and the second exposure, in which there are substantially no adsorbed gas particles M can be reduced, thus making it possible to prevent a great change in the X-ray dose emitted from the X-ray tube 1.

Further, the displacement between the central axis 16b of the focusing cup and the central axis 14b of the filament is only made in a direction parallel to the central axis 14b of the filament and the central axis 15b of the storage slot and further an arrangement direction of the three electron guns 12, 13, and 13, and therefore the cathode 10 can be easily designed.

Further, in this embodiment, the central axis 16b the focusing cup is displaced from the central axis 14b of the filament by a dimension of the radius of the filament 14 or more (a half its width or more). With this configuration, direct collision on the filament 14 can be substantially avoided.

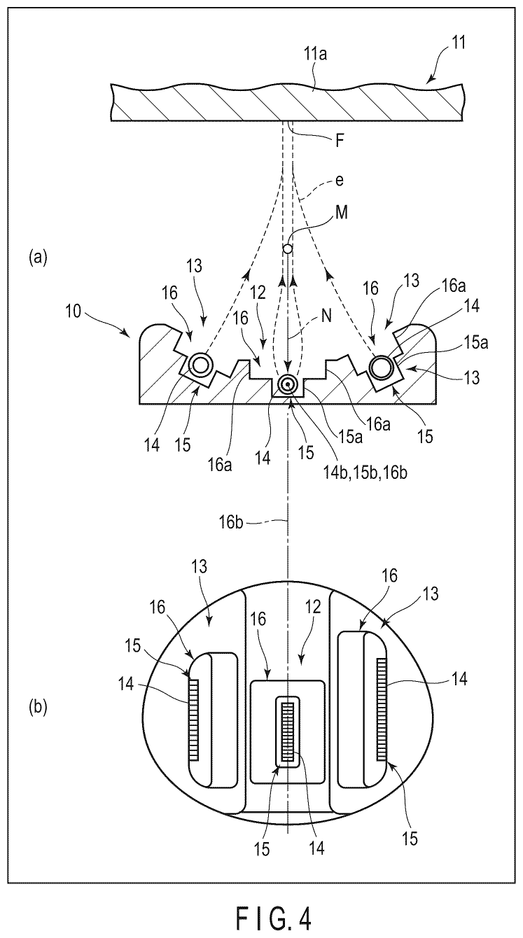

FIG. 4 shows a comparative example. According to the comparative example in FIG. 4, in the central electron gun 12 formed on the cathode 10, it shows a state in which the central axis 14b of the filament, the central axis 15b of the storage slot, and the central axis 16b of the focusing cup coincide with each other.

As is clear from this comparative example shown in FIG. 4, when the central axis 16b of the focusing cup is coincident with the central axis 14b of the filament, positive ions N ionized from the adsorbed gas particles M proceed directly to the central axis 14b of the filament and collide with the filament 14. Therefore, in the comparative example shown in FIG. 4, the temperature of the filament 14 rises due to the collision of the positive ions N and the electron beams emitted from the central electron gun 12 increase as a phenomenon, which may result in a large change in the X-ray dose emitted from the X-ray tube 1 between the case where there are adsorbed gas particles M and the case where there is not.

In contrast, according to this embodiment, the central axis 16b of the focusing cup is displaced from the central axis 14b of the filament, as described above. Therefore, when there are adsorbed gas particles M, the collision of the positive ions on the filament 14 can be reduced and the increasing of the electron beams due to the temperature rise of the filament 14 can be suppressed. In this manner, it is possible to prevent a large change in the X-ray dose emitted from the X-ray tube between the case where there are adsorbed gas particles M and the case where there is not.

In the following, other embodiments will be described. In the embodiments described below, parts that exhibit the same operational effects as those of the first embodiment described above will be marked with the same reference symbols and detailed descriptions thereof will be omitted.

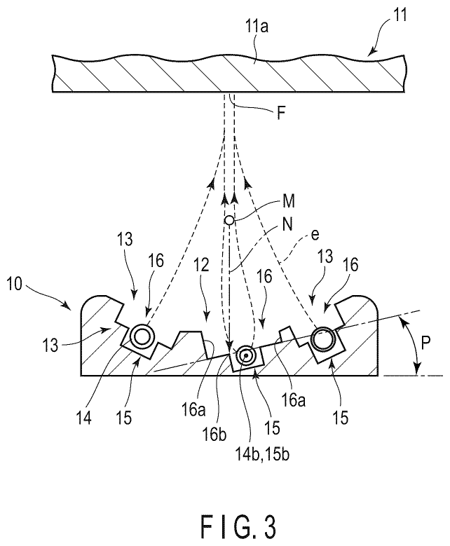

The second embodiment will now be described with reference to FIG. 3.

In the second embodiment, the central electron gun 12 is installed inclined at an angle P. The central axis 14b of the filament and the central axis 15b of the storage slot are coincident with each other.

According to this second embodiment, advantageous effects similar to those of the first embodiment can be obtained. Further, the storage slot 15 and the focusing cup 16 both are provided to be inclined at an angle P in order to make the central axis 14b of the filament and the central axis 16b of the focusing cup coincident with each other. Thus, it becomes easy to carry out the designing for obtaining a trajectory to focus electrons e at the focal point F.

As described, in the second embodiment, the trajectories of electrons e emitted from the filament 14 of the central electron gun 12 are less biased on the left and right sides, and therefore left and right cup walls 16a of the focusing cup 16 can be formed substantially in symmetry. Therefore, the designing of the cathode 10 is simple in this respect as well.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The filament 14 as the electron emission source is not limited to a coiled filament, but various types of filaments can be used. For example, the cathode 10 may have a flat filament in place of a coiled filament. In this case, advantageous effects similar to those of the embodiment described above can be obtained. The flat filament is a filament having an upper surface (electron emitting surface) of the flat filament and a rear surface as planes.

For example, the embodiments of the invention are not limited to the rotating anode X-ray tube 1 described above, but are applicable to various types of 10 rotating anode X-ray tubes, various types of fixed anode X-ray tubes and other X-ray tubes.

What is claimed is:

1. An X-ray tube comprising:
an anode including a target layer that emits an X-ray when an electron beam is incident thereon;
a cathode in which three electron guns are arranged in parallel with each other, each including a filament which emits electrons, a storage slot which stores the filament, and a focusing cup which focuses the electrons emitted from the filament toward the target layer as an electron beam, wherein
the three electron guns are constituted by a central electron gun which opposes the anode and electron guns located on respective sides thereof while interposing the central electron gun therebetween, and the focusing cup of each of the electron guns is formed to be continuous to the respective slot and the filament is disposed to project out from the storage slot to the focusing cup, and
the central electron gun includes a central axis of the filament along a longitudinal direction at a center of the filament in a width direction thereof and a central axis of the storage slot along a longitudinal direction at a center of the storage slot in a width direction thereof, which coincide with each other, and a central axis of the focusing cup along a longitudinal direction at a center of the focusing cup in a width direction thereof that is displaced from the central axis of the filament.

2. The X-ray tube of claim 1, wherein
the central axis of the focusing cup is parallel to the central axis of the filament and the central axis of the storage slot is displaced from an arrangement direction of the three electron guns.

3. The X-ray tube of claim 2, wherein
the central axis of the focusing cup is distant from the central axis of the filament by a half a width or more of the filament.
